(19) United States
(12) Patent Application Publication
(10) Pub. No.: US 2010/0219363 A1
(43) Pub. Date: Sep. 2, 2010

(54) LOW FORCE ANTI STICKING THROTTLE VALVE

(75) Inventors: Robert J. Telep, Livonia, MI (US); Martin P. Bogen, St. Clair Shores, MI (US)

Correspondence Address: WARN, HOFFMANN, MILLER & OZGA, P.C., P.O. BOX 70098, ROCHESTER HILLS, MI, 48307, US

(73) Assignee: BORGWARNER INC., Auburn Hills, MI (US)

(21) Appl. No.: 12/376,991

(22) PCT Filed: Aug. 14, 2007
(86) PCT No.: PCT/US07/18134

§ 371 Date: Apr. 1, 2010

Related U.S. Application Data
(60) Provisional application No. 60/837,532, filed on Aug. 14, 2006.

(51) Int. Cl. F16K 1/22

(52) U.S. Cl. 251/305

(57) ABSTRACT

A valve assembly having a body, a valve, a contact surface of the valve, and a gap surface of the valve. The body has an interior surface that defines a flow passage. The valve is positioned in the body. The valve is positioned at an angle with respect to the interior surface of the body when the valve is in a closed position in order to prevent the valve from sticking to the body. The contact surface contacts the interior surface of the body when the valve is in a closed position. The gap surface is spaced apart from the interior surface when the valve is in the closed position.

### CROSS-REFERENCE TO RELATED APPLICATIONS

This application claims the benefit of U.S. Provisional Application No. 60/837,532, filed Aug. 14, 2006. The disclosure of the above application is incorporated herein by reference.

### FIELD OF THE INVENTION

The present invention relates to an anti-sticking valve assembly.

### BACKGROUND OF THE INVENTION

The use of valves in a path of fluid flow has always presented certain obstacles that must be addressed. Such obstacles include thermal expansion or contraction of the valve assembly. When the valve assembly is used in applications where the fluid flowing through the valve assembly is substantially lower or greater in temperature than ambient conditions, the valve heats up or cools down causing components to expand or contract.

Valve assemblies typically have a bore or flow passage with a valve member that functions as a moveable obstruction that controls the fluid flow. Often the bore or flow passage is made of different materials that will expand and contract differently. For example, in a throttle body the bore and butterfly valve are often made of different materials which will expand at different rates. As a result of this expansion, the butterfly valve member can become stuck if it expands faster than the surrounding bore. Further, the valve and bore can expand at different rates because the valve is in the direct flow path of the fluid and the bore is offset from the direct flow path of the fluid.

Therefore, it is desirable to develop a valve assembly where the valve has minimum leakage when in the closed position, does not stick due to thermal expansion, and requires low operating forces.

### SUMMARY OF THE INVENTION

A valve assembly having a body, a valve, a contact surface of the valve, and a gap surface of the valve. The body has an interior surface that defines a flow passage. The valve is positioned in the body. The valve is positioned at an angle with respect to the interior surface of the body when the valve is in a closed position in order to prevent the valve from sticking to the body. The contact surface contacts the interior surface of the body when the valve is in a closed position. The gap surface is spaced apart from the interior surface when the valve is in the closed position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional plan view of a valve in a closed position;

FIG. 2 is a schematic cross-sectional side view of the valve in an open position;

FIG. 3 is a schematic cross-sectional side view of the valve in a closed position;

FIG. 4 is a cross-sectional plan view of a round valve in the closed position and an oval body in accordance with an embodiment of the present invention;

FIG. 5 is a cross-sectional plan view of an undersized oval valve in the closed position in a round body in accordance with an embodiment of the present invention;

FIG. 6 is a cross-sectional plan view of an oval valve in the closed position and an oval body in accordance with an embodiment of the present invention;

FIG. 7a is a cross-sectional plan view of a valve having at least one protrusion in the closed position and a body in accordance with an embodiment of the present invention;

FIG. 7b is a cross-sectional plan view of a body having at least one protrusion and a valve in accordance with an embodiment of the present invention;

FIG. 8 is a cross-sectional plan view of a valve having at least one straight edge in the closed position and a body in accordance with an embodiment of the present invention; and

FIGS. 9a and 9b are schematic cross-sectional side views of the valve in the closed position at an off-set angle from a body prior to and after the valve and body increase in size due to thermal expansion.

### DETAILED DESCRIPTION OF THE PREFERRED EMBODIMENTS

The following description of the preferred embodiment(s) is merely exemplary in nature and is in no way intended to limit the invention, its application, or uses.

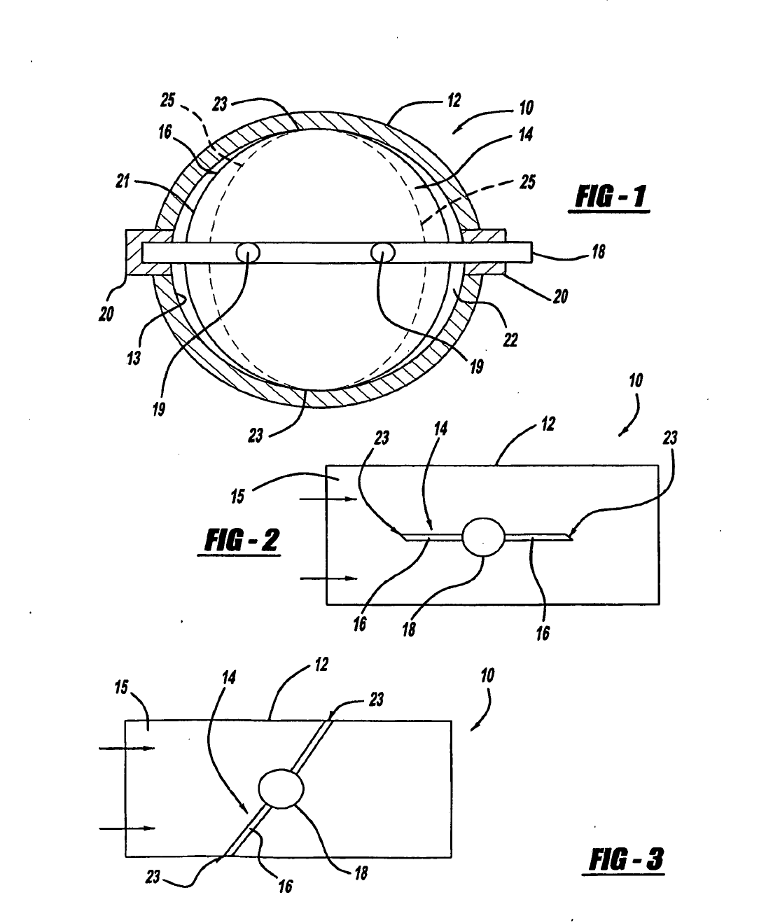

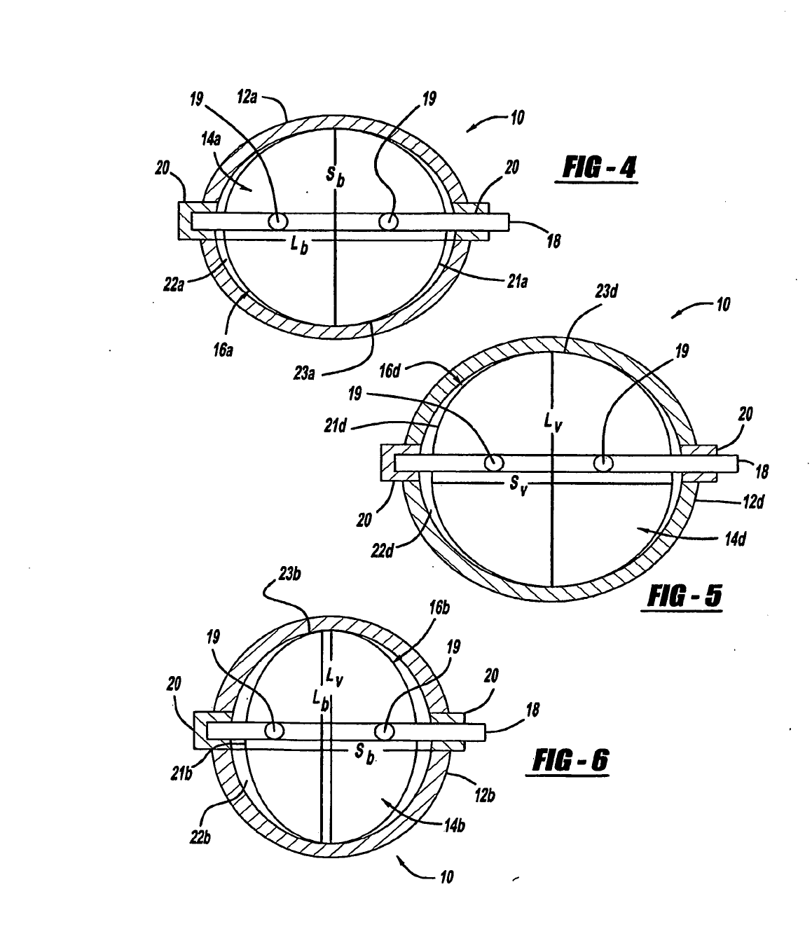

Referring to FIGS. 1-3, a valve assembly is generally shown at 10. The valve assembly 10 provides a body or bore 12 having an interior surface 13 and a valve generally indicated at 14. The interior surface 13 defines a flow passage 15. The valve 14 has a circumferential surface generally indicated at 16 in which a portion of the circumferential surface 16 is adjacent to the body 12 when the valve 14 is in a fully closed position. FIGS. 1 and 3 show the valve 14 in the fully closed position. When the valve 14 is not in the fully closed position, the circumferential surface 16 is not adjacent to the body 12, as shown in FIG. 2.

The valve 14 is operably connected to a shaft 18 which extends through the body 12. As the shaft 18 rotates the valve 14 will rotate within the body 12 between the open and closed positions. The valve 14 is connected to the shaft 18 by any suitable attachment device such as but not limited to, a fastener 19, such as a rivet, nut and bolt combination, welding, adhesive, or the like. Further, the shaft 18 is operably connected to the body 12 by at least one bushing 20 which allows for the shaft 18 to rotate in order to open and close the valve 14. However, it should be appreciated that any suitable attachment device can be used in order to connect the shaft 18 to the body 12 which allows the shaft 18 to rotate.

The valve 14 as shown in the FIGS. 1-3 is an undersized valve 14, meaning that the surface area of the valve 14 is smaller than the surface area of the body 12. The circumferential surface 16 of the valve 14 has a contact area shown generally at 23 that contacts the inside surface of the body 12. A gap surface 21 of the circumferential surface 16 is spaced away from the interior surface 15 of the body 12 and defines a gap 22, between the interior surface 15 and gap surface 21. The size of the gap will vary as the valve 14 and body 12 expand and contract as a result of thermal expansion. This is shown in dashed lines 25 in FIG. 1. The presence of a gap 22 near the shaft 18 is not completely required; however, it is beneficial because it is not possible to move the valve 14 away from the body 12 at these points. Preferably, the gap 22 has a maximum size of 150 microns; however, the gap 22 can be varied depending on several factors, for example, the gap 22 size may vary depending on the anticipated thermal expansion between the various components of the valve assembly 10. Further, the gap 22 can decrease in size from the gap surface 21 to the contact surface 23. At the contact surface 23 there does not need to be a gap 22 because as the valve 14 and body 12 expand the valve member will rotate to alter the angle of the valve 14 with respect to the body 12 in order to compensate for the thermal expansion.

FIGS. 9a and 9b show the position of the valve 14 in the body 12 before and after thermal expansion. FIG. 9a shows the valve 14 in the closed position in the body 12 before thermal expansion has occurred. The valve 14 is positioned or off-set at an angle “X” with respect to the body 12. When valve assembly 10 heats up the valve 14 can expand at a different rate than the body 12. The thermal expansion can be caused by several different factors such as, but not limited to, material thickness and material composition. FIG. 9b depicts the valve assembly 10 after thermal expansion has occurred. The valve 14 has expanded at a greater rate than the body 12. In order to compensate for the thermal expansion the contact surface 23 of the valve 14 will slide along the inside surface of the body 12 and cause the shaft 18 and valve 14 to rotate. The valve 14 will be rotated or off-set to a greater angle “Y” while still maintaining the valve 14 in the closed position. Additionally, the valve 14 will not stick in the body 12 because the thermal expansion of the valve 14 has been taken into account by the repositioning of the valve 14. Further, the angle of the circumferential surface 16 allows for the valve 14 to seal or contact the body 12. It is also within the scope of this invention for the same arrangement of valve 14 in the body 12 to be used in valve assemblies where thermal contraction occurs as the result of cooling of valve components.

When the valve 14 is in the closed position, the valve 14 is off-set at a predetermined angle from a perpendicular position with respect to the body 12. Preferably, the predetermined off-set angle is 20 degrees; however, a greater or lesser angle can be used depending on the particular application. The placement of the 14 in the body 12 at an angle with respect to the body 12, while maintaining a gap 22 can also be achieved by varying the shape of the valve 14 and the body 12. Some of the various configurations will be discussed in FIGS. 4-8 below.

In an embodiment shown in FIG. 4, a valve 14a having a round shape and a body 12a having an oval shape so that a contact surface 23a contacts the side of the body 12a having a shorter radius S_{b}, when the valve 14a is in the closed position. Thus, a gap surface 21a defines a gap 22a with the side of the body 12a that has the larger radius L_{b}.

FIG. 5 depicts a valve 14d having an oval shape and a body 12d having a round shape. Thus, at least one end of a side of the valve 14d that forms the longer radius Lᵥ of the valve 14d forms a contact surface 23d which contacts the body 12d when the valve 14d is in the closed position. The remaining sides of the valve 14d that form the shorter radius Sᵥ of the valve 14d forms a gap surface 21 which defines a gap 22d with the body 12d.

In reference to another embodiment shown in FIG. 6, a body 12b and a valve 14b having an oval shape, and an end forming a contact surface 23b is on at least one end of the valve 14b forming a longer radius Lᵥ of the valve 14b. The longer radius Lᵥ of the valve 14b is greater than the longer radius L_{b} of the body 12b. Thus, the contact surface 23b contacts the body 12b when the valve 14b is in the closed position. Also, a gap surface 21b defines a gap 22b with the side of the body 12b having the shorter radius S_{b}.

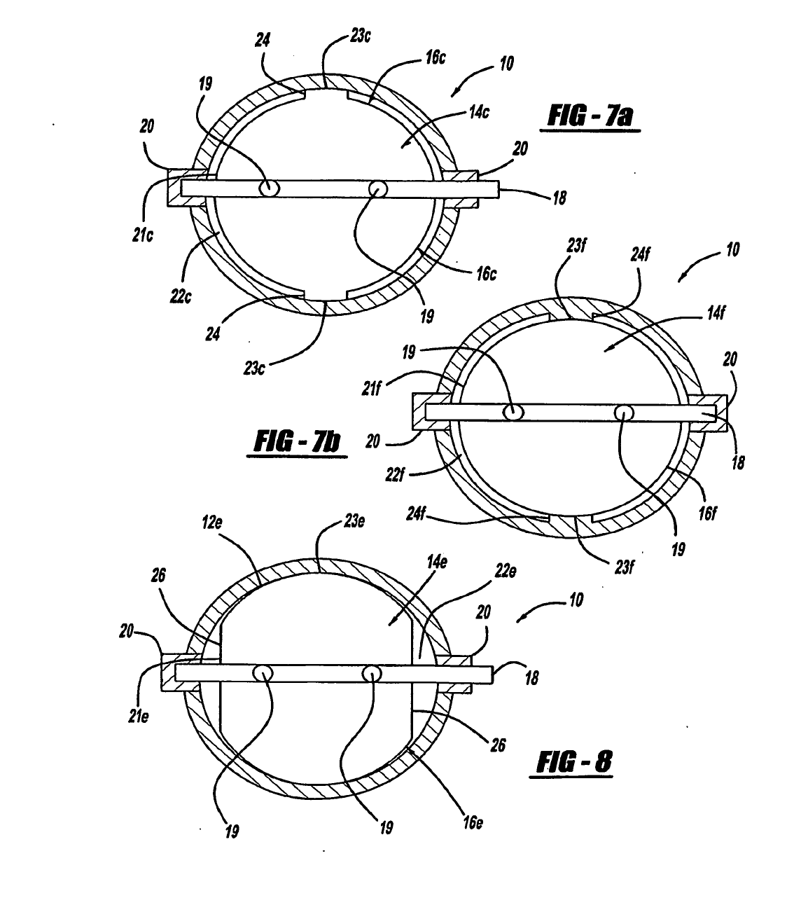

In an embodiment shown in FIG. 7a, a valve 14c has at least one protrusion 24 extending radially outward from a circumferential surface 16c. The protrusion 24 forms at least a portion of a contact surface 23c which contacts the body 12c when the valve 14c is in the closed position. A gap surface 21c defines a gap 22c with the body 12c.

In reference to FIG. 7b, an embodiment is shown where a body 12f has at least one protrusion 24f extending radially inward from the interior surface 13f. The protrusion 24f contacts at least a portion of a contact surface 23f of a valve 14f when the valve 14f is in the closed position. A gap surface 21f defines a gap 22f with the body 12f.

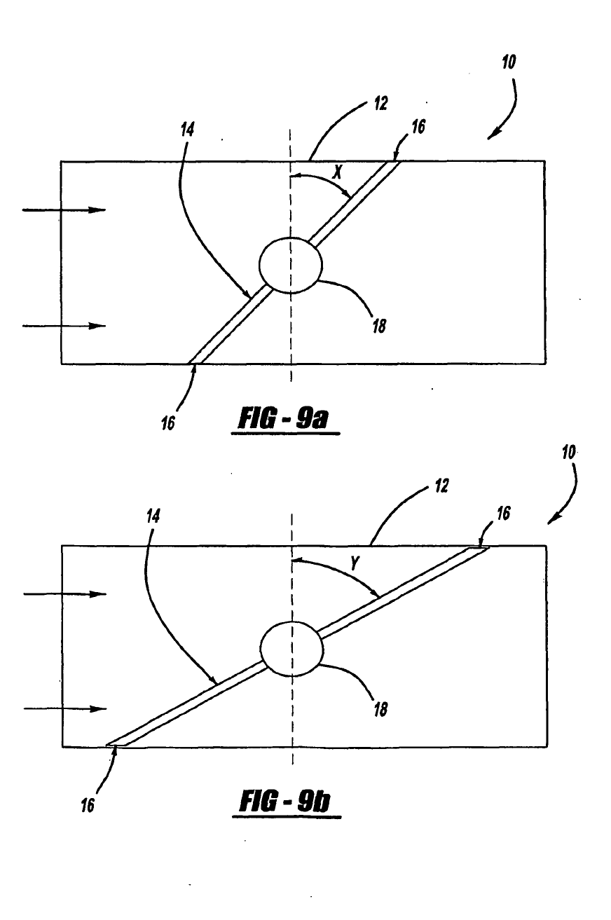

In another embodiment shown in FIG. 8, a valve 14e has a portion of a circumferential surface 16e that is adjacent a body 12e when the valve 14e is in the closed position, and a gap surface 21e is a straight edge 26 which is adjacent the shaft 18. The straight edge 26 defines at least a portion of a gap 22e. Preferably, a contact surface 23e of the valve 14e contacts the body 12e when the valve 14e is in the closed position.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A valve assembly comprising:
a body having an interior surface that defines a flow passage;
a valve positioned in said body, wherein said valve is positioned at an angle with respect to said interior surface of said body when said valve is in a closed position in order to prevent said valve from sticking in said body;
a contact surface of said valve that contacts said interior surface of said body when said valve is in said closed position; and
a gap surface of said valve that is spaced apart from said interior surface when said valve is in said closed position.

2. The valve assembly of claim 1, wherein said valve has a round shape and said body has an oval shape so that said contact surface contacts at least one side of said body having a shorter radius when said valve is in said closed position.

3. The valve assembly of claim 1, wherein said valve and said body have an oval shape, and an end forming said contact surface is on at least one end of said valve forming a longer radius of said valve which is greater than a longer radius of said body so that said contact surface of said valve contacts said body.

4. The valve assembly of claim 1, further comprising at least one protrusion extending radially outward from said valve forming at least a portion of said contact surface so that said at least one protrusion contacts said interior surface of said body when said valve is in said closed position.

5. The valve assembly of claim 1 further comprising at least one protrusion extending radially inward from said interior surface of said body, wherein said at least one protrusion contacts at least a portion of said contact surface when said valve is in said closed position.

6. The valve assembly of claim 1, wherein said valve has an oval shape and said body has a round shape so that at least one end of a side forming a longer radius of said valve forms said contact surface and contacts said body when said valve is in said closed position.

7. The valve assembly of claim 1, wherein thermal expansion of said valve assembly decreases the space between said gap surface and said interior surface.

8. The valve assembly of claim 1, wherein said angle of said valve with respect to said body increases when at least one of said valve or said body increase in size due to thermal expansion.

9. The valve assembly of claim 1 further comprising a shaft, wherein said shaft is operably connected to said valve.

10. The valve assembly of claim 9, wherein at least a portion of said gap surface of said valve is substantially perpendicular to a connection of said shaft and said valve.

11. A valve assembly comprising:
a body having an interior surface that defines a flow passage;
a valve positioned at an angle with respect to said interior surface of said body when said valve is in a closed position in order to prevent said valve from sticking in said body;
a shaft operably connected to said valve;
a contact surface of said valve that contacts said interior surface of said body when said valve is in said closed position; and
a gap surface of said valve adjacent said shaft, wherein said gap surface is spaced apart from said interior surface when said valve is in said closed position.

12. The valve assembly of claim 11, wherein at least a portion of said gap surface is substantially perpendicular to a connection of said shaft and said valve.

13. The valve assembly of claim 11, wherein said valve has an oval shape and said body has a round shape so that at least one side forming the longer radius of said valve forms said contact surface that contacts said body when said valve is in said closed position.

14. The valve assembly of claim 11, wherein said valve has a round shape and said body has an oval shape so that said contact surface contacts at least one side forming the shorter radius of said body when said valve is in said closed position.

15. The valve assembly of claim 11, wherein said valve and said body have an oval shape, and a longer radius of said valve is greater than a longer radius of said body so that said contact surface contacts said body when said valve is in said closed position.

16. The valve assembly of claim 11, wherein at least one protrusion extending radially outward from said valve forming at least a portion of said contact surface so that said at least one protrusion contacts said interior surface of said body when said valve is in said closed position.

17. The valve assembly of claim 11 further comprising at least one protrusion extending radially inward from said interior surface of said body, wherein said at least one protrusion contacts at least a portion of said contact surface when said valve is in said closed position.

18. The valve assembly of claim 11, wherein thermal expansion of said valve assembly decreases the space between said gap surface and said interior surface.

19. The valve assembly of claim 11, wherein said angle of said valve with respect to said body increases when at least one of said valve or said body increase in size due to thermal expansion.

20. A valve assembly comprising:
a bore having an interior surface that defines a flow passage wherein said bore has a round shape;
a valve positioned at an angle with respect to said interior surface of said bore when said valve is in a closed positioning order to prevent said valve from sticking in said bore, wherein said valve has an oval shape;
a shaft operably connected to said valve;
a contact surface of said valve that contacts said interior surface of said bore when said valve is in said closed position; and
a gap surface of said valve that is adjacent said shaft, wherein said gap surface is spaced apart from said interior surface when said valve is in said closed position.

21. The valve assembly of claim 20, wherein thermal expansion of said valve assembly decreases the space between said gap surface and said interior surface.

22. The valve assembly of claim 20, wherein said angle of said valve with respect to said body increases when at least one of said valve or said body increase in size due to thermal expansion.
